(19) United States
(12) Patent Application Publication
(10) Pub. No.: US 2009/0078285 A1
(43) Pub. Date: Mar. 26, 2009

(54) Method and Device for Cleaning Pipe Runs

(76) Inventors: Tauno Marttinen, Nummela (FI); Mika Laakso, Veikkola (FI); Kaj Pelamo, Veikkola (FI)

Correspondence Address: JOEL D. SKINNER, JR.;SKINNER AND ASSOCIATES, 212 COMMERCIAL ST., HUDSON, WI, 54016, US

(21) Appl. No.: 11/918,148

(22) PCT Filed: Apr. 10, 2006
(86) PCT No.: PCT/FI2006/000109

§ 371 Date: Oct. 10, 2007

(30) Foreign Application Priority Data
Apr. 12, 2005 (FI) 20050368

(51) Int. Cl. B08B 9/027

(52) U.S. Cl. 134/18; 435/264; 134/22.14; 134/21; 134/57 R

(57) ABSTRACT

The invention relates to a method for keeping vacuum piping, particularly the vacuum piping (2, 3, 4) of the waste systems of ships and similar, clean, or for assisting it. The device according to the invention is used to feed acid and bacteria are fed to the end of each vacuum pipe run (3). The feeding takes place mainly automatically by means of controllable hose pumps (102), provided a predefined vacuum prevails in the vacuum pipe run (3).

The present invention relates to a method and device for cleaning pipe runs. In particular, it relates to a drainpipe system, which is used in ships and similar locations.

The drain systems of ships at sea are nearly always vacuum-operated. In practice, this means that the material, consisting of faeces, paper, and similar, contained in the pipe system, moves at quite a slow pace, aided by a vacuum. Movement takes place when, for example, a toilet is flushed, when a certain amount of replacement air is permitted to enter the system through a valve, to carry the substances in the toilet bowl some distance forward.

It is obvious that a system like that depicted above brings with it certain drawbacks, of which the foremost is the accumulation of material on the walls of the piping. In addition, material also increases due to local growths.

Due to the danger of the piping becoming blocked, it must be cleaned now and then by using quite strong cleaning procedures. One such conventional procedure is acid cleaning of the piping. In practice, acid cleaning takes place by emptying the piping and then filling it with quite a strong solution of acid, allowing this to act for a certain time, and then flushing the acid out.

The operation is very demanding and heavy and, due to the handling of acid, brings with it many hazards. The strong acid requires special treatment as waste too.

One way to solve the problem is also the manual addition of acid when washing the toiler bowls. If desired, bacteria can also be added to the manual process, which improves the effect of the acid. Such a dry mixture, containing both acid and bacteria is also commercially available.

Manual treatment with acid also contains risks, due to the acid component. At the same time, dosing is often random, which has the result that, on the one hand too little material is used, while on the other dosing is heavy and thus expensive.

The present invention is intended to create a method and apparatus, with the aid of which the drawbacks of the prior art can be resolved in a sensible manner.

The aforementioned and other benefits and advantages of the invention are achieved by means of the method and device defined in the claims.

In the following, the invention is examined in greater detail, with reference to the accompanying schematic figures, which show one embodiment of the device according to the invention.

Thus;

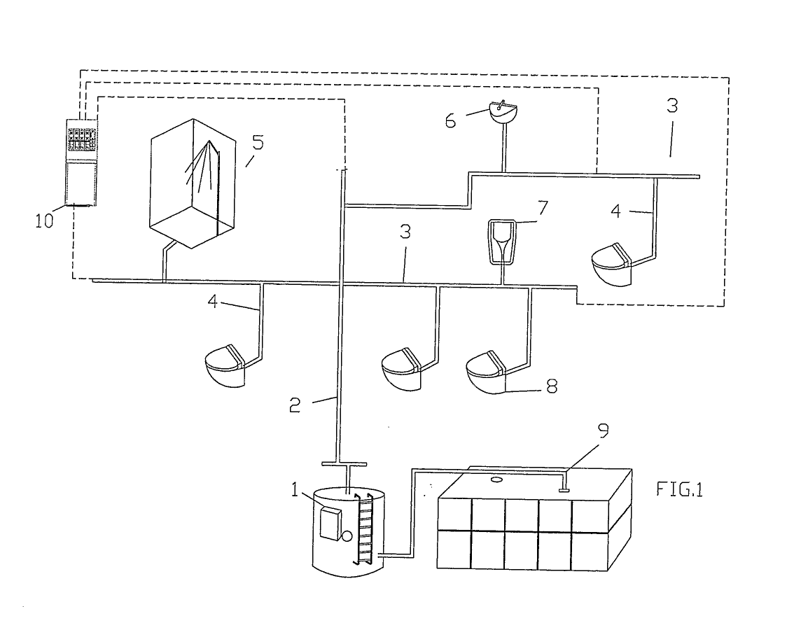

FIG. 1 shows a partial general view of a system, to which the method and device according to the invention can be applied; and

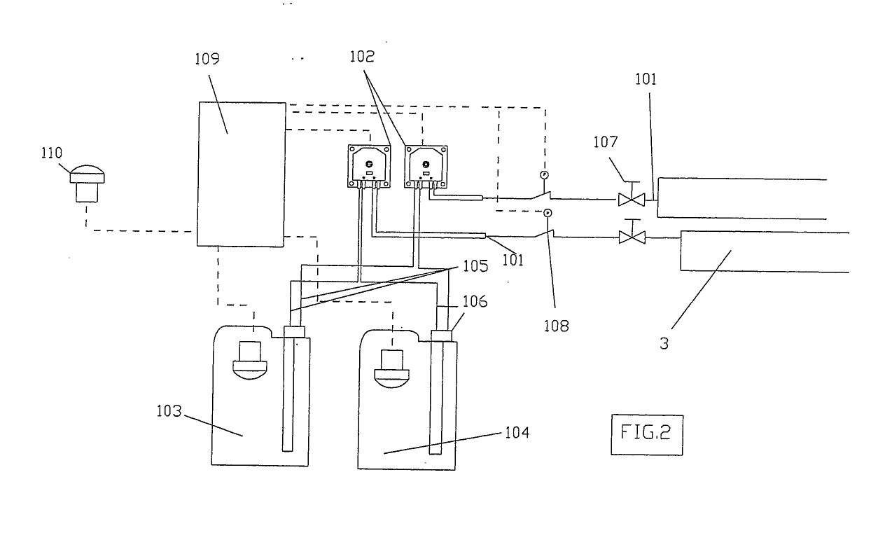

FIG. 2 shows an example of one connection, with the aid of which the method and device according to the invention can operate.

Thus FIG. 1 shows a quite typical apparatus totality, which is used in a modern ship, and to which the apparatus according to the invention is connected.

Briefly, the vacuum-collection unit 1 acts as a collector tank, in which any material moving in the ship's vacuum system accumulates through the effect of the vacuum. The vacuum can be created in any known manner whatever, some sort of ejector systems being usual. The pressure is adjusted to keep it at the desired level, within a pressure range that is acceptable in operating terms.

All the material comes to the collection unit along the main trunk line 2, to which in turn the essentially horizontal trunk lines 3 coming at different levels from the various parts of the ship are connected. The lines 4 from the individual appliances are in turn connected to these numerous trunk lines 3.

The individual appliances are, in turn, mainly showers 5, various basins 6, urinals 7, and WC bowls 8. Only one alternative location of the lines and the appliances is shown, though in practice there are many other location alternatives than those now shown.

The material collected in the collection unit 1 can, if desired, be led to a separate waste-treatment plant 9, from where it is finally emptied for further treatment.

The devices or devices according to the invention are located at suitable places in the ship. For example, one apparatus can be placed in the bows, to function at one end of the pipelines, while a second apparatus can be correspondingly placed in the stern.

The idea is that the apparatus includes a pump or pumps, with the aid of which acid and/or bacteria are fed from the ends of the vacuum pipelines in a managed and controlled manner, so that they act in the pipes continuously, thus preventing excess growth and, for example, adhesion to the walls of the piping arising from slow movement. The total apparatus comprising the dosing equipment is marked by the reference number 10 in FIG. 1.

As stated, FIG. 2 shows one example of a stripped-down connection model for operating the device according to the invention and for exploiting the method.

In this case too, the ends of the vacuum lines, which are shown in FIG. 1, are marked with the reference number 3. The feed pipes 101 are brought to the end of the lines 3 from the pumps 102. In turn, vacuum lines 105 run to the pumps 102 from the tank 103 containing acid while also separate vacuum lines 106 run from the tank 104 containing a bacterial solution. The pump combines these two solutions as desired. If wished, the tanks are equipped with a sensor detecting the surface level, for example, in order to notify of a need to change or fill them.

It is obvious that the dosing of the acid can be separated from the dosing of the bacterial solution, so that both solutions use their own pump.

Valves 107, which are open only during the periodical feeding, are connected to the feed line in a conventional manner. On the other hand, if the feed is continuous, the valves 107 only act as safety devices and for detaching the apparatus according to the invention from the system.

Reference number 108 is used to mark vacuum switches, which are intended to monitor the pressure in the piping 3 and to prevent, in a fault situation, the device according to the invention from feed acid/bacteria to the pipes. In this specific case, the switches 108 monitor the pressure through the feed lines 101, which are then naturally open in the direction of the pipe 3.

The control centre of the apparatus is shown schematically by a box 109. The leak detector 110, which is also shown schematically, is to give an alarm in situation in which a leak occurs somewhere in the piping. For example, the apparatus according to the invention uses double piping, in which the outer pipe acts as a safety device. If a leak occurs in the inner pipe, the liquid will travel between the pipes to a point where it can flow out and this escaped liquid is detected and, if necessary, to automatically switch off the apparatus and give an alarm.

As already stated above, the system according to the invention can either operate continuously, or as a cyclic doser. Compared to traditional systems, it achieves, however, very even dosing, which means that there is continuously acid and/or bacteria in the vacuum piping, so that the effect is also continuous and the possibility of deleterious blockages arising in the piping is eliminated.

A conventional vacuum piping comprises a vacuum of 0.3-0.8 bar. The device according to the invention monitors this vacuum and operates only if the pressure is within the preset limits. In addition, the device according to the invention can be set to monitor that, after the flushing, the pressure in the piping returns to its full value. It is obvious that if the piping begins to be blocked, material will of course continue to flow, but also that the probability of a blockage that will require action will increase. In such situations, the apparatus can automatically increase the feed on acid/bacteria.

According to the invention, conventional acids, salt acids, phosphoric acids, or nowadays preferably more environmentally-friendly organic acids are used. The bacteria used are of types that are used in other compounds used for opening drains. There are several types of bacteria available on the market, which are not harmful to nature and thus safe to use.

According to the invention, particularly so-called hose pumps, in which the substances being fed do not come into direct contact with the impellers, pistons, or similar feed elements, are used. Problems of durability always arise with strong acids. A hose pump eliminates these problems. They are easy to program also to feed small amounts of liquid. Multi-channel versions of hose pumps that are suitable for application in a hospital environment can also be found on the market. According to the invention, the number of feed channels must be adapted to the system being used. A sufficient number of pumps are used to achieve the desired feed effect.

It is obvious that the above description provides only an outline of the operating principle of the invention and that it can be adapted in many ways, while nevertheless remaining within the scope of the protection of the inventive idea and the accompanying claims.

1. Method for keeping vacuum piping, including the vacuum piping of the waste systems of ships, clean, comprising the step of feeding acid and bacteria essentially continuously to an end of each vacuum pipe run of a vacuum piping network.

2. Method according to claim 1, characterized in that the step of feeding involves an acid/bacteria solution and is performed as a time-controlled operation between specific vacuum values of the vacuum pipe run.

3. Method according to claim 2, characterized in that the step of feeding is performed within a vacuum range of about 0.3-0.8 bar.

4. Method according to claim 2, further comprising the step of obtaining information about the speed of return of vacuum after operation of the vacuum piping network, characterized in that the amount of the acid/bacteria solution fed is adjusted according to the information that is obtained about the speed of return of the vacuum after the operation of the vacuum piping network.

5. Device for keeping vacuum piping, including the vacuum piping of waste systems of ships, clean, comprising:
a tank for acid and a tank for a bacterial solution,
pumps,
a controller device,
vacuum piping from the tanks to the pumps, and
piping for feeding the acid/bacterial solutions to an end of an essentially horizontal pipe run of the vacuum piping being cleaned, according to control provided by the controller device.

6. Device according to claim 5, characterized in that the pumps are hose pumps.

7. Device according to claim 5, further comprising a switch and characterized in that the controller device prevents, on the basis of information received from the switch, the feed of acid/bacterial solution outside pre-selected vacuum limits values of the vacuum piping being cleaned.

8. Device according to claim 5, characterized in that it further comprises a leak detector for detecting leaks and for preventing feed, if a leak appears.
